(19) United States
(12) Patent Application Publication
(10) Pub. No.: US 2024/0305083 A1
(43) Pub. Date: Sep. 12, 2024

(54) WIRING MODULE AND ELASTIC WATER-STOP MEMBER

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hirokazu KOMORI, Osaka (JP); Tsubasa MARUYAMA, Osaka (JP)

(21) Appl. No.: 18/269,198

(22) PCT Filed: Dec. 7, 2021
(86) PCT No.: PCT/JP2021/044933

§ 371 Date: Jun. 22, 2023

(30) Foreign Application Priority Data
Dec. 23, 2020 (JP) 2020-214035

(51) Int. Cl. H02G 15/013; H02G 15/04

(52) U.S. Cl. CPC H02G 15/013; H02G 15/04

(57) ABSTRACT

The purpose of the present invention is to make it possible to more reliably arrange a wiring member inside a wiring member arrangement hole in a case where an elastic water-blocking member is given a split structure. This wiring module is provided with: a wiring member which includes at least one linear wiring member; and an elastic water-blocking member that is mounted to a portion of the wiring member in the lengthwise direction thereof. The elastic water-blocking member includes a first split member and a second split member. One of the first split member and the second split member has formed therein: wiring member arrangement grooves having openings on both ends and a slender elongated opening; and a pair of guide wall portions. The other of the first split member and the second split member has formed therein a convex lid portion that is arranged within the pair of guide wall portions so as to close off the slender elongated opening. In a state in which the first split member and the second split member are combined together, at least a portion of the wiring member is arranged in a linear wiring member arrangement hole which is enclosed by the wiring member arrangement grooves and the convex lid portion.

### TECHNICAL FIELD

The present disclosure relates to a wiring module and an elastic water-stop member.

### BACKGROUND

Patent Document 1 discloses a sealing structure of a multi-core cable provided with a rubber plug. The rubber plug is formed with through holes. Wires are sealed by being passed through the through holes.

### PRIOR ART DOCUMENT

### Patent Document

Patent Document 1: JP 2016-010303 A

### SUMMARY OF THE INVENTION

### Problems to be Solved

To facilitate the arrangement of the wires in the through holes, a divided structure of the rubber plug is considered.

In this case, it is required to enable the wires to be more reliably arranged in the through holes.

Accordingly, the present disclosure aims to enable a wiring member to be more reliably arranged in a wiring member arrangement hole when an elastic water-stop member has a divided structure.

### Means to Solve the Problem

The present disclosure is directed to a wiring module with a wiring member including at least one linear wiring member, and an elastic water-stop member mounted on a part in a longitudinal direction of the wiring member, the elastic water-stop member including a first divided member and a second divided member, one of the first and second divided members being formed with a wiring member arrangement groove having openings on both end sides and an elongated opening, a pair of guiding wall portions being formed to project outwardly of the wiring member arrangement groove from both side edges of the elongated opening of the wiring member arrangement groove, the other of the first and second divided members being formed with a convex lid portion for closing the elongated opening by being arranged between the pair of guiding wall portions, and at least a part of the wiring member being arranged in a wiring member arrangement hole surrounded by the wiring member arrangement groove and the convex lid portion with the first and second divided members united.

The present disclosure is also directed to an elastic water-stop member to be mounted on a part in a longitudinal direction of a wiring member including at least one linear wiring member, the elastic water-stop member being provided with a first divided member and a second divided member, one of the first and second divided members being formed with a wiring member arrangement groove having openings on both end sides and an elongated opening, a pair of guiding wall portions being formed to project outwardly of the wiring member arrangement groove from both side edges of the elongated opening of the wiring member arrangement groove, the other of the first and second divided members being formed with a convex lid portion for closing the elongated opening by being arranged between the pair of guiding wall portions, and a wiring member arrangement hole capable of arranging at least a part of the wiring member therein by being surrounded by the wiring member arrangement groove and the convex lid portion being formed with the first and second divided members united.

### Effect of the Invention

According to this wiring module, if the wiring member cannot be pushed into the wiring member arrangement groove in arranging at least a part of the wiring member into the wiring member arrangement groove, the wiring member is arranged between the pair of guiding wall portions. If the first and second divided members are united in this state, the convex lid portion pushes the wiring member between the pair of guiding wall portions into the wiring member arrangement groove and closes the elongated opening. Thus, when the elastic water-stop member has a divided structure, at least a part of the wiring member is more reliably arranged in the wiring member arrangement hole surrounded by the wiring member arrangement groove and the convex lid portion with the first and second divided members united.

Further, according to this elastic water-stop member, if the wiring member cannot be pushed into the wiring member arrangement groove in arranging at least a part of the wiring member into the wiring member arrangement groove, the wiring member is arranged between the pair of guiding wall portions. If the first and second divided members are united in this state, the convex lid portion pushes the wiring member between the pair of guiding wall portions into the wiring member arrangement groove and closes the elongated opening. Thus, when the elastic water-stop member has a divided structure, at least a part of the wiring member is more reliably arranged in the wiring member arrangement hole surrounded by the wiring member arrangement groove and the convex lid portion with the first and second divided members united.

### BRIEF DESCRIPTION OF THE DRAWINGS

FIG. 1 is a perspective view showing a wiring module according to an embodiment.

FIG. 2 is an exploded perspective view showing the wiring module.

FIG. 3 is an exploded perspective view showing the wiring module.

FIG. 4 is an exploded perspective view showing an elastic water-stop member.

FIG. 5 is a front view showing the elastic water-stop member.

FIG. 6 is a front view showing an arrangement example of linear wiring members with respect to the elastic water-stop member.

FIG. 7 is a front view showing an elastic water-stop member according to a modification.

FIG. 8 is a front view showing the elastic water-stop member according to the modification.

FIG. 9 is a front view showing an elastic water-stop member according to another embodiment.

### DETAILED DESCRIPTION TO EXECUTE THE INVENTION

### Description of Embodiments of Present Disclosure

First, embodiments of the present disclosure are listed and described.

The wiring module of the present disclosure is as follows.

(1) The wiring module is provided with a wiring member including at least one linear wiring member, and an elastic water-stop member mounted on a part in a longitudinal direction of the wiring member, the elastic water-stop member including a first divided member and a second divided member, one of the first and second divided members being formed with a wiring member arrangement groove having openings on both end sides and an elongated opening, a pair of guiding wall portions being formed to project outwardly of the wiring member arrangement groove from both side edges of the elongated opening of the wiring member arrangement groove, the other of the first and second divided members being formed with a convex lid portion for closing the elongated opening by being arranged between the pair of guiding wall portions, and at least a part of the wiring member being arranged in a wiring member arrangement hole surrounded by the wiring member arrangement groove and the convex lid portion with the first and second divided members united.

According to this wiring module, if the wiring member cannot be pushed into the wiring member arrangement groove in arranging at least a part of the wiring member into the wiring member arrangement groove, the wiring member is arranged between the pair of guiding wall portions. If the first and second divided members are united in this state, the convex lid portion pushes the wiring member between the pair of guiding wall portions into the wiring member arrangement groove and closes the elongated opening. Thus, when the elastic water-stop member has a divided structure, at least a part of the wiring member is more reliably arranged in the wiring member arrangement hole surrounded by the wiring member arrangement groove and the convex lid portion with the first and second divided members united.

(2) In the wiring module of (1), the wiring member includes a plurality of the linear wiring members, the elastic water-stop member further includes a third divided member, one of the second and third divided members is formed with the wiring member arrangement groove and the pair of guiding wall portions, the other of the second and third divided members is formed with the convex lid portion, and the plurality of linear wiring members are arranged in the wiring member arrangement holes each surrounded by the wiring member arrangement groove and the convex lid portion between the first and second divided members and between the first and third divided members with the first, second and third divided members united. In this case, at least parts of the wiring members are arranged not only between the first and second divided members, but also between the second and third divided members. Thus, water can be stopped for each of the plurality of linear wiring members included in the wiring member.

(3) In the wiring module of (2), each of a part facing the first divided member and a part facing the third divided member, out of the second divided member, is formed with the wiring member arrangement groove and the pair of guiding wall portions, and each of the first and third divided members is formed with the convex lid portion. In this case, an operation of uniting the first and third divided members with the second divided member is easily performed with the linear wiring members of the wiring member arranged in the respective wiring member arrangement grooves of the second divided member.

(4) In the wiring module of (2), the first divided member is formed with the wiring member arrangement groove and the pair of guiding wall portions, a part facing the first divided member, out of the second divided member, is formed with the convex lid portion, a part facing the third divided member, out of the second divided member, is formed with the wiring member arrangement groove and the pair of guiding wall portions, and the third divided member is formed with the convex lid portion. In this case, the first and second divided members can be united with the linear wiring member arranged in the wiring member arrangement groove of the first divided member, and the third divided member can be united with the second divided member with the other linear wiring member arranged in the wiring member of the second divided member.

(5) In the wiring module of any one of (1) to (4), a depth of the wiring member arrangement groove is larger than a radius of the linear wiring member and a width of the elongated opening is smaller than a diameter of the linear wiring member. In this case, the linear wiring member is temporarily held in the wiring member arrangement groove.

(6) In the wiring module of any one of (1) to (5), heights of the pair of guiding wall portions are equal to or larger than a radius of the linear wiring member. In this way, the linear wiring member is less likely to be detached from the pair of guiding wall portions.

(7) In the wiring module of any one of (1) to (6), the pair of guiding wall portions have guide surfaces, a spacing between the guide surfaces being gradually narrowed toward the elongated opening. In this way, the linear wiring member is easily guided toward the elongated opening by the guide surfaces.

(8) In the wiring module of any one of (1) to (7), an exterior member including a first exterior member and a second exterior member unitable with each other is further provided, and the elastic water-stop member is accommodated in the exterior member with the first and second exterior members united. In this case, the first and second divided members can be kept in the united state by the exterior member.

(9) In the wiring module of (8), one of the exterior member and the elastic water-stop member is formed with an erroneous assembly preventing protrusion, and the other of the exterior member and the elastic water-stop member is formed with an erroneous assembly preventing recess, the erroneous assembly preventing protrusion being fit into the erroneous assembly preventing recess. In this way, the assembly of the elastic water-stop member in a wrong posture with the exterior member is suppressed.

Further, the elastic water-stop member of the present disclosure is as follows.

(10) The elastic water-stop member is to be mounted on a part in a longitudinal direction of a wiring member including at least one linear wiring member, the elastic water-stop member being provided with a first divided member and a second divided member, one of the first and second divided members being formed with a wiring member arrangement groove having openings on both end sides and an elongated opening, a pair of guiding wall portions being formed to project outwardly of the wiring member arrangement groove from both side edges of the elongated opening of the wiring member arrangement groove, the other of the first and second divided members being formed with a convex lid portion for closing the elongated opening by being arranged between the pair of guiding wall portions, and a wiring member arrangement hole capable of arranging at least a part of the wiring member therein by being surrounded by the wiring member arrangement groove and the convex lid portion being formed with the first and second divided members united.

In this way, if the wiring member cannot be pushed into the wiring member arrangement groove in arranging at least a part of the wiring member into the wiring member arrangement groove, the wiring member is arranged between the pair of guiding wall portions. If the first and second divided members are united in this state, the convex lid portion pushes the wiring member between the pair of guiding wall portions into the wiring member arrangement groove and closes the elongated opening. Thus, when the elastic water-stop member has a divided structure, at least a part of the wiring member is more reliably arranged in the wiring member arrangement hole surrounded by the wiring member arrangement groove and the convex lid portion with the first and second divided members united.

### Details of Embodiment of Present Disclosure

Specific examples of a wiring module and an elastic water-stop member of the present disclosure are described below with reference to the drawings. Note that the present disclosure is not limited to these illustrations, but is represented by claims and intended to include all changes in the scope of claims and in the meaning and scope of equivalents.

### Embodiment

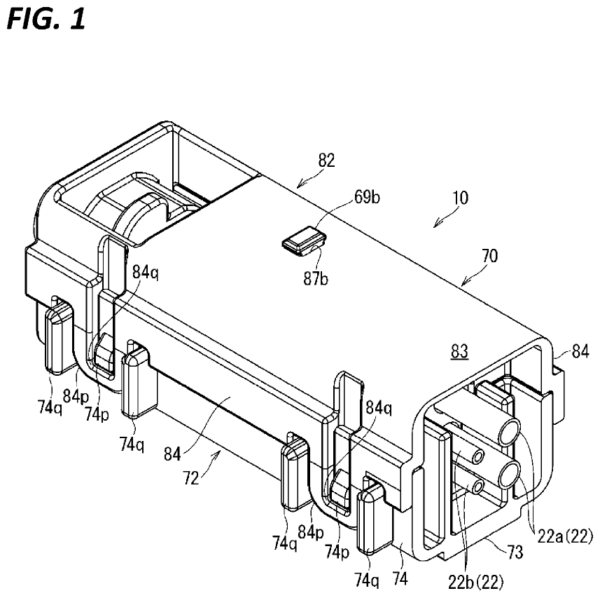

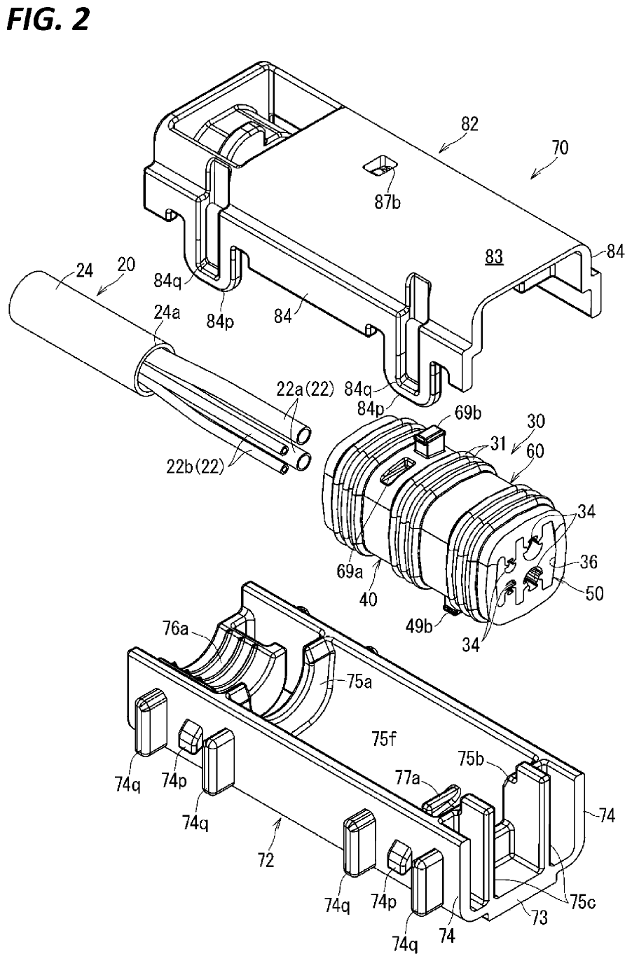

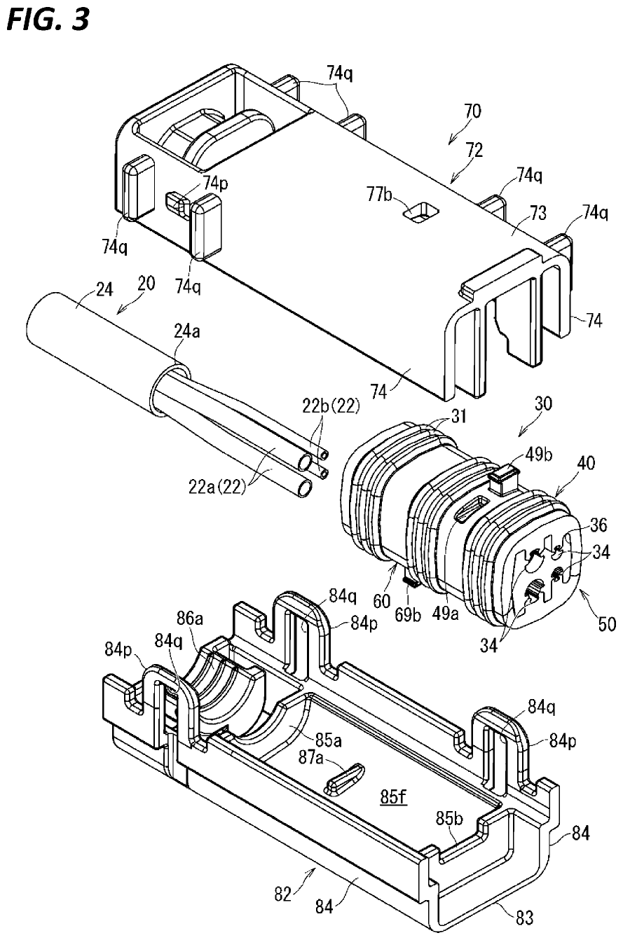

Hereinafter, a wiring module provided with an elastic water-stop member according to an embodiment is described. FIG. 1 is a perspective view showing a wiring module 10. FIGS. 2 and 3 are exploded perspective views showing the wiring module 10. FIG. 2 is a perspective view from the side of a second exterior member 82, and FIG. 3 is a perspective view from the side of a first exterior member 72. In each figure, a wiring member 20 is partially shown.

The wiring module 10 is provided with the wiring member 20 and an elastic water-stop member 30. In this embodiment, the wiring module 10 is further provided with an exterior member 70. The elastic water-stop member 30 is mounted on a part in a longitudinal direction of the wiring member 20. In this state, the wiring member 20 is passed through the elastic water-stop member 30. Water intrusion along the periphery of the wiring member 20 is suppressed by the elastic water-stop member 30. The elastic water-stop member 30 is accommodated into the exterior member 70. In this way, a state where the wiring member 20 is passed through the elastic water-stop member 30 is maintained.

The configuration of each component is described.

The wiring member 20 includes at least one linear wiring member 22. The wiring member 20 may include only one linear wiring member 22 or may include a plurality of linear wiring members 22. In this embodiment, the wiring member 20 includes a plurality of (four, here) the linear wiring members 22. The linear wiring member 22 is, for example, a coated wire in which a resin coating is formed around a core wire. The linear wiring member may be a cable in which a plurality of wires are covered with a sheath. The linear wiring member may include an electromagnetic shield layer such as a braided wire. The linear wiring member may be a signal wire, a power supply wire or a ground wire.

In this embodiment, the wiring member 20 includes linear wiring members having mutually different thicknesses as the plurality of linear wiring members 22. In the following description, these linear wiring members may be distinguished as thick linear wiring members 22a and thin linear wiring members 22b for the sake of convenience. Here, the wiring member 20 includes two linear wiring members 22a and two linear wiring members 22b.

The wiring member 20 includes a coating member 24 for covering parts in the longitudinal direction of the plurality of linear wiring members 22. The coating member 24 is, for example, a sheath formed, such as by extruding softened and melted resin to cover around the linear wiring members 22. The coating member 24 may be an adhesive tape spirally wound around the linear wiring members 22. The coating member 24 may also be a corrugated tube, a resin tube, a resin sheet or the like externally mounted on the linear wiring members 22. Parts of the plurality of linear wiring members 22 covered by the coating member 24 are kept bundled by the coating member 24. Parts of the plurality of linear wiring members 22 coming out from the coating member 24 may be branched into a plurality of parts.

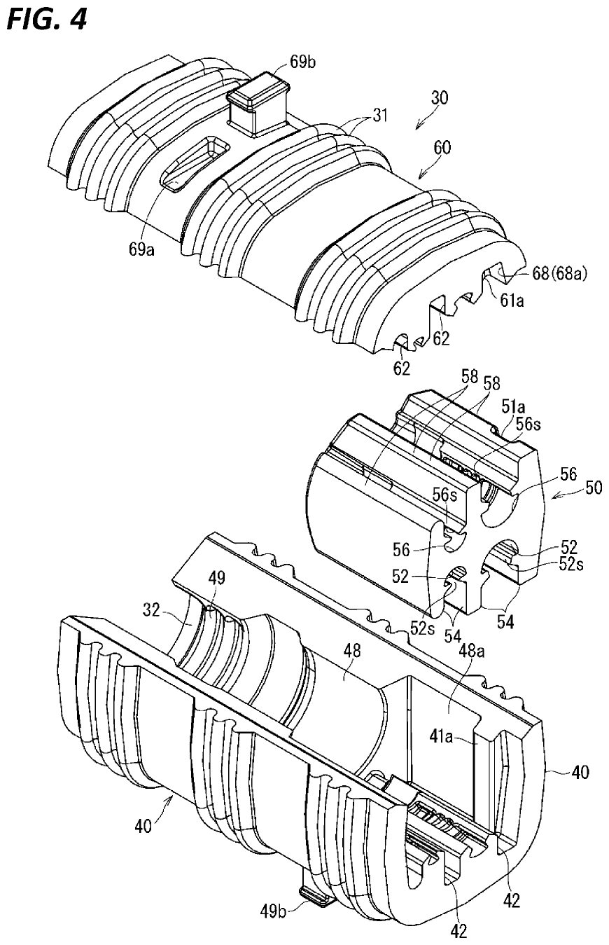

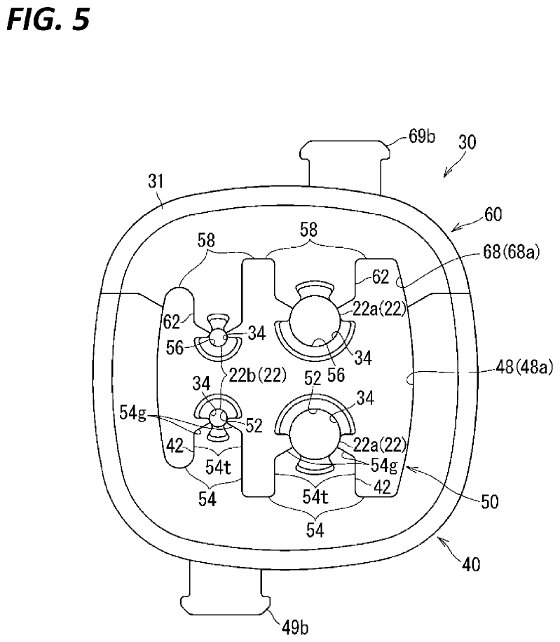

FIG. 4 is an exploded perspective view showing the elastic water-stop member 30. FIG. 5 is a front view showing the elastic water-stop member 30.

The overall configuration of the elastic water-stop member 30 is described. As shown in FIGS. 1 to 5, the elastic water-stop member 30 is formed of an elastic material such as silicone rubber. In this embodiment, the elastic water-stop member 30 is formed into a rectangular column shape with rounded corners. Besides, the elastic water-stop member may be formed into a cylindrical shape or the like.

Annular protrusions 31 are formed on the outer periphery of the elastic water-stop member 30. With the elastic water-stop member 30 accommodated in the exterior member 70, the annular protrusions 31 are in contact with the inner peripheral surface of the exterior member 70 while being elastically deformed. In this way, the elastic water-stop member 30 can be accommodated into the exterior member 70 while being compressively deformed mainly at the annular protrusions 31.

Out of the wiring member 20, an end part 24a of the coating member 24 and parts of the linear wiring members 22 extending from the end part 24a of the coating member 24 are accommodated in the elastic water-stop member 30. Thus, a coating member arrangement hole 32 for accommodating the end part of the coating member 24 is formed in one end part of the elastic water-stop member 30. Further, linear wiring member arrangement holes 34 capable of accommodating the linear wiring members 22 are formed in the other end part of the elastic water-stop member 30. In this embodiment, a plurality of the linear wiring member arrangement holes 34 are formed in the other end part of the elastic water-stop member 30. In the elastic water-stop member 30, the plurality of linear wiring member arrangement holes 34 are connected to the common coating member arrangement hole 32. Thus, the plurality of linear wiring members 22 extending from the coating member 24 arranged in the coating member arrangement hole 32 can be separately arranged in the plurality of linear wiring member arrangement holes 34. Note that the plurality of linear wiring member arrangement holes 34 have different inner diameters to correspond to the linear wiring members 22a, 22b having different thicknesses.

The elastic water-stop member 30 includes a first divided member 40 and a second divided member 50. In this embodiment, the elastic water-stop member 30 further includes a third divided member 60. The first, second and third divided members 40, 50 and 60 are members obtained by dividing the elastic water-stop member 30. Planes dividing these may be parallel to the linear wiring members 22.

The first and third divided members 40, 60 are formed into shapes obtained by dividing an outer peripheral part of the elastic water-stop member 30 into two. In this embodiment, the first divided member 40 is formed to have a larger shape than the third divided member 60. The first and third divided members 40, 60 may be shaped by equally dividing the outer peripheral part of the elastic water-stop member 30 into two.

Out of the first divided member 40, a part facing the third divided member 60 is formed with an accommodation recess 48. The accommodation recess 48 is in the form of a groove open on both end sides of the first divided member 40. A part near one end of the first divided member 40, out of the accommodation recess 48, is formed into a coating accommodation recess 49 for accommodating the coating member 24. A part near the other end of the first divided member 40, out of the accommodation recess 48, is formed into an intermediate divided member accommodating portion 48a capable of accommodating the second divided member 50.

Out of the third divided member 60, a part facing the first divided member 40 is formed with an accommodation recess 68. The accommodation recess 68 is in the form of a groove open on both end sides of the third divided member 60. The accommodation recess 68 is shallower than the accommodation recess 48. Apart near one end of the third divided member 60, out of the accommodation recess 68, is formed into a coating accommodation recess for accommodating the coating member 24. With the first and third divided members 40, 60 united, the coating member arrangement hole 32 in the form of a circular hole and capable of accommodating the end part of the coating member 24 is formed by the coating accommodation recess 49 and the coating accommodation recess. A part near the other end of the third divided member 60, out of the accommodation recess 68, is formed into an intermediate divided member accommodating portion 68a capable of accommodating the second divided member 50. With the first and third divided members 40, 60 united, an intermediate divided member accommodation hole 36 capable of accommodating the second divided member 50 is formed by the intermediate divided member accommodating portion 48a and the intermediate divided member accommodating portion 68a. The intermediate divided member accommodation hole 36 is formed on an extension of the coating member arrangement hole 32.

With the second divided member 50 partially accommodated in the intermediate divided member accommodating portion 48a of the first divided member 40, the third divided member 60 is put on the first divided member 40 to close an opening of the accommodation recess 48 in the first divided member 40. In this state, a part protruding from the intermediate divided member accommodating portion 48a, out of the second divided member 50, is accommodated in the intermediate divided member accommodating portion 68a in the third divided member 60. In this way, the first, second and third divided members 40, 50 and 60 are united.

Further, one of the first and second divided members 40, 50 is formed with a divided member erroneous assembly preventing protrusion 41a, and the other is formed with a divided member erroneous assembly preventing recess 51a. Here, the divided member erroneous assembly preventing recess 51a is formed at a position near an outer end part in one side part of the second divided member 50. The divided member erroneous assembly preventing recess 51a is in the form of a groove extending from the side of the first divided member 40 toward the side of the third divided member 60. Further, the divided member erroneous assembly preventing protrusion 41a having an elongated convex shape extending from the bottom toward an end part of the intermediate divided member accommodating portion 48a is formed at a position corresponding to the divided member erroneous assembly preventing recess 51a on one of inner side surfaces of the intermediate divided member accommodating portion 48a in the first divided member 40. Note that, in this embodiment, a divided member erroneous assembly preventing protrusion 61a having an elongated convex shape extending from the bottom toward an end part of the intermediate divided member accommodating portion 68a is formed at a position corresponding to the divided member erroneous assembly preventing recess 51a on one of inner side surfaces of the intermediate divided member accommodating portion 68a in the third divided member 60. The divided member erroneous assembly preventing protrusion 61a is formed on an extension of the divided member erroneous assembly preventing protrusion 41a.

In a posture in which the divided member erroneous assembly preventing protrusion 41a is arranged in the divided member erroneous assembly preventing recess 51a, the second divided member 50 can be arranged in the intermediate divided member accommodating portion 48a in the first divided member 40. In other postures, the divided member erroneous assembly preventing protrusion 41a interferes with the outer side surface of the second divided member 50 and it becomes difficult to arrange the second divided member 50 in the intermediate divided member accommodating portion 48a in the first divided member 40. Similarly, in a posture in which the divided member erroneous assembly preventing protrusion 61a is arranged in the divided member erroneous assembly preventing recess 51a, the third divided member 60 can be united on the second divided member 50 united with the first divided member 40. In other postures, the divided member erroneous assembly preventing protrusion 61a interferes with the outer side surface of the second divided member 50 and it becomes difficult to unite the third divided member 60 on the second divided member 50 united with the first divided member 40.

Wiring member arrangement grooves 52 are formed in one of the first and second divided members 40, 50. In this embodiment, the wiring member arrangement grooves 52 are formed in the second divided member 50. The wiring member arrangement groove 52 is a part forming a partial peripheral surface in a circumferential direction, out of the inner peripheral surface of the linear wiring member arrangement hole 34. Both end sides of the wiring member arrangement groove 52 are open. One side of the wiring member arrangement groove 52 is open inside the elastic water-stop member 30, and the other end side of the wiring member arrangement groove 52 is open to the outside of the elastic water-stop member 30. A side of the wiring member arrangement groove 52 opposite to a bottom part is formed into an elongated opening 52s. The elongated opening 52s is formed into a slit connecting openings on both end sides of the wiring member arrangement groove 52.

A depth of the wiring member arrangement groove 52 is preferably larger than a diameter of the linear wiring member 22 to be arranged in the wiring member arrangement groove 52. Further, the wiring member arrangement groove 52 preferably has a shape larger than half the circular cross-section of the linear wiring member 22 to be arranged in the wiring member arrangement groove 52. Further, an opening width of the elongated opening 52s is preferably smaller than a diameter of the linear wiring member 22 to be arranged in the wiring member arrangement groove 52.

A pair of guiding wall portions 54 project outwardly of the wiring member arrangement groove 52 from both side edges of the elongated opening 52s of the wiring member arrangement groove 52. The pair of guiding wall portions 54 project in parallel from the both side edges of the elongated opening 52s toward a side opposite to the bottom of the wiring member arrangement groove 52 while being spaced apart. In this embodiment, two wiring member arrangement grooves 52 are formed in parallel and each of these is formed with the pair of guiding wall portions 54. An interval between the pair of guiding wall portions 54 on the side of the wiring member arrangement groove 52 for the thick linear wiring member 22a is larger than that between the pair of guiding wall portions 54 on the side of the wiring member arrangement groove 52 for the thin linear wiring member 22b. The guiding wall portion 54 between the two wiring member arrangement grooves 52 is the guiding wall portion 54 common to the two wiring member arrangement grooves 52.

A gap equal to or more than the diameter of the linear wiring member 22 is preferably formed between the pair of guiding wall portions 54. Heights of the pair of guiding wall portions 54 are preferably equal to or more than the radius of the linear wiring member 22 and more preferably equal to or more than the diameter of the linear wiring member 22. The height of the guiding wall portion 54 may be a height from an outer edge part of the elongated opening 52s.

The pair of guiding wall portions 54 preferably have guide surfaces 54g, a spacing between which is gradually narrowed toward the elongated opening 52s. In this example, parts on the side of the elongated opening 52s, out of the pair of guiding wall portions 54, are formed into the guide surfaces 54g extending toward a center between the pair of guiding wall portions 54 as extending toward the elongated opening 52s. Parts opposite to the elongated opening 52s, out of the pair of guiding wall portions 54, are formed into restricting surfaces 54t extending in directions parallel to each other. Thus, the linear wiring member 22 pushed into between the pair of guiding wall portions 54 moves toward the wiring member arrangement groove 52 while being guided by the restricting surfaces 54t and is guided toward the elongated opening 52s in the center between the pair of guiding wall portions 54 by being guided by the pair of guide surfaces 54g on the back sides of the pair of guiding wall portions 54. Then, the linear wiring member 22 can be pushed into the wiring member arrangement groove 52 through the elongated opening 52s.

The other of the first and second divided members 40, 50 is formed with convex lid portions 42. The convex lid portion 42 is a part for closing the elongated opening 52s by being arranged between the pair of guiding wall portions 54 with the first and second divided members 40, 50 united. Here, the convex lid portions 42 are formed in the first divided member 40. More specifically, two convex lid portions 42 are formed side by side in a bottom part of the intermediate divided member accommodating portion 48a. Each of the two convex lid portions 42 is formed into a shape corresponding to the inner surfaces of the pair of guiding wall portions 54. That is, both side surfaces of the base end of the convex lid portion 42 are formed into surfaces extending in parallel to correspond to the pair of restricting surfaces 54t. Both side surfaces of a tip part of the convex lid portion 42 are formed into surfaces inclined to gradually narrow a spacing therebetween toward a tip side to correspond to the pair of guide surfaces 54g. Thus, the convex lid portion 42 can be accommodated between the pair of guiding wall portions 54 with gaps between the convex lid portion 42 and the inner surfaces of the pair of guiding wall portions 54 eliminated.

Further, the tip part of the convex lid portion 42 is a part forming a partial peripheral surface in the circumferential direction, out of the inner peripheral surface of the linear wiring member arrangement hole 34 and, more specifically, a part forming a remaining peripheral surface of the part formed by the wiring member arrangement groove 52, out of the inner peripheral surface of the linear wiring member arrangement hole 34. Here, the tip part of the convex lid portion 42 is formed into an arcuate groove shape having a shorter radius than the radius of the linear wiring member 22. By arranging the convex lid portion 42 between the pair of guiding wall portions 54, the tip part of the convex lid portion 42 is arranged in the elongated opening 52s. In this state, the tip surface of the convex lid portion 42 and the inner peripheral surface of the wiring member arrangement groove 52 are annularly connected. In this way, the wiring member arrangement holes 34 constituted by the inner peripheral surfaces of the wiring member arrangement grooves 52 and the tip surfaces of the convex lid portions 42 are formed with the first and second divided members 40, 50 united.

Lip portions and reinforcing wall portions are formed on an inner peripheral part of the wiring member arrangement groove 52. The lip portion is an elongated arcuate protrusion extending along a circumferential direction of the wiring member arrangement groove 52. Here, a plurality of the lip portions are formed at intervals in a longitudinal direction of the wiring member arrangement groove 52. The reinforcing wall portion is an elongated protrusion extending along an extending direction of the wiring member arrangement groove 52 inside the elongated opening 52s of the wiring member arrangement groove 52. Lip portions and reinforcing wall portions similar to the lip portions and the reinforcing wall portions in the wiring member arrangement groove 52 are formed in a shallow arcuate groove part in the tip part of the convex lid portion 42.

With the linear wiring member 22 arranged in the wiring member arrangement groove 52, each lip portion can be held in close contact with the outer peripheral surface of the linear wiring member 22 while being elastically deformed. Further, with the first and second divided members 40, 50 united, the reinforcing wall portions on the side of the wiring member arrangement groove 52 and those on the side of the convex lid portion 42 are in contact with each other. In this way, gaps are hardly formed between the first and second divided members 40, 50.

In this embodiment, one of the second and third divided members 50, 60 is formed with wiring member arrangement grooves 56 and pairs of guiding wall portions 58. Here, the wiring member arrangement grooves 56 and the pairs of guiding wall portions 58 are formed in the second divided member 50. The wiring member arrangement grooves 56 are parts similar to the wiring member arrangement grooves 52, and the pairs of guiding wall portions 58 are parts similar to the pairs of guiding wall portions 54. The second divided member 50 may be symmetrically shaped with respect to a plane passing through a center between the wiring member arrangement grooves 52 and the wiring member arrangement grooves 56.

The other of the second and third divided members 50, 60 is formed with convex lid portions 62. Here, the third divided member 60 is formed with a pair of the convex lid portions 62. More specifically, the pair of convex lid portions 62 are formed side by side in a bottom part of the intermediate divided member accommodating portion 68a in the third divided member 60. The pair of convex lid portions 62 are parts similar to the pair of convex lid portions 42 described above.

By arranging the convex lid portion 62 between the pair of guiding wall portions 58 with the second and third divided members 50, 60 united, a tip part of the convex lid portion 62 is arranged in an elongated opening 56s of the wiring member arrangement groove 56. In this state, the tip surface of the convex lid portion 62 and the inner peripheral surface of the wiring member arrangement groove 52 are annularly connected. In this way, the wiring member arrangement hole 34 constituted by the inner peripheral surface of the wiring member arrangement groove 56 and the tip surface of the convex lid portion 62 is formed with the second and third divided members 50, 60 united.

Thus, in this embodiment, the wiring member arrangement grooves 52 and the pairs of guiding wall portions 54 are formed in a part of the second divided member 50 facing the first divided member 40, and the wiring member arrangement grooves 56 and the pairs of guiding wall portions 58 are formed in a part of the second divided member 50 facing the third divided member 60. Further, each of the first and third divided members 40, 60 is formed with the convex lid portions 42, 62.

The exterior member 70 is a member for accommodating the elastic water-stop member 30, particularly a member for covering the outer periphery of the elastic water-stop member 30 with the first, second and third divided members 40, 50 and 60 kept united. The exterior member 70 is provided with the first exterior member 72 and the second exterior member 82 unitable with each other. The elastic water-stop member 30 is accommodated in the exterior member 70 with the first and second exterior members 72, 82 united.

More specifically, each of the first and second exterior members 72, 82 is a member formed of resin or the like.

The first exterior member 72 includes a bottom plate portion 73 and a pair of side wall portions 74. The bottom plate portion 73 is in the form of a rectangular plate. The pair of side wall portions 74 stand on both sides of the bottom plate portion 73. Uniting protrusions 74p are formed on the outer surfaces of the side wall portions 74. The uniting protrusion 74p is formed into a shape having a projecting dimension gradually reduced toward a tip side of the side wall portion 74. Guide protrusions 74q are formed on both outer sides of the uniting protrusion 74p. The guide protrusion 74q is formed into an elongated protrusion shape extending from a base end side toward the tip side of the side wall portion 74.

A water-stop member divided holding surface 75f corresponding to a part of the outer peripheral surface shape of the elastic water-stop member 30 is formed in a longitudinal intermediate part of the bottom plate portion 73. A part of the elastic water-stop member 30, particularly an outer peripheral surface part of the first divided member 40, is accommodated on the water-stop member divided holding surface 75f.

A first positioning portion 75a is provided on one end part of the water-stop member divided holding surface 75f. The first positioning portion 75a is formed into a U shape projecting further inward than the inner peripheral surface of the water-stop member divided holding surface 75f. A recess capable of arranging the coating member 24 therein is formed in the first positioning portion 75a. A semi-tubular holding portion 76a capable of accommodating the coating member 24 is formed on the one end part of the bottom plate portion 73. The semi-tubular holding portion 76a is located on the outer side of the first positioning portion 75a. Protrusions along a circumferential direction are formed on the inner peripheral surface of the semi-tubular holding portion 76a. A part of the coating member 24 of the wiring member 20 extending from the elastic water-stop member 30 is held in the semi-tubular holding portion 76a through the first positioning portion 75a.

A second positioning portion 75b is provided on the other end part of the water-stop member divided holding surface 75f. The second positioning portion 75b is formed into a U shape projecting further inward than the inner peripheral surface of the water-stop member divided holding surface 75f. A pair of restricting wall portions 75c are provided side by side on the outer side of the second positioning portion 75b while being spaced apart. The linear wiring members 22 extending from the elastic water-stop member 30 extend outward through a recess in the second positioning portion 75b and between the pair of restricting wall portions 75c.

A positioning protrusion 77a is formed on one side of a part near the second positioning portion 75b, out of the water-stop member divided holding surface 75f, and a positioning recess 77b is formed adjacent to the positioning protrusion 77a. The positioning protrusion 77a projects from the water-stop member divided holding surface 75f, and the positioning recess 77b is recessed from the water-stop member divided holding surface 75f.

A water-stop member side positioning recess 49a, into which the positioning protrusion 77a is fittable, is formed at a position corresponding to the positioning protrusion 77a on the outer peripheral surface of the first divided member 40, out of the elastic water-stop member 30, and a water-stop member side positioning protrusion 49b fittable into the positioning recess 77b is formed adjacent to the water-stop member side positioning recess 49a. If the elastic water-stop member 30 is arranged on the water-stop member divided holding surface 75f in such a posture that the linear wiring member arrangement holes 34 of the elastic water-stop member 30 are facing toward the second positioning portion 75b, the positioning protrusion 77a can be fit into the water-stop member positioning recess 49a and, at the same time, the water-stop member side positioning protrusion 49b can be fit into the positioning recess 77b. If an attempt is made to set the first divided member 40 in the first exterior member 72 in a posture different from the above one, the positioning protrusion 77a interferes with the outer surface of the first divided member 40 and the water-stop member side positioning protrusion 49b interferes with the water-stop member divided holding surface 75f. The first divided member 40 can be set in a correct posture in the first exterior member 72 based on whether the above interference is present or not.

The positioning protrusion 77a and the water-stop member side positioning recess 49a are examples of an erroneous assembly preventing protrusion and an erroneous assembly preventing recess, and the water-stop member side positioning protrusion 49a and the positioning recess 77b are also examples of the erroneous assembly preventing protrusion and the erroneous assembly preventing recess. Either one or both of these may be omitted.

The first divided member 40 is set on the water-stop member divided holding surface 75f with the water-stop member side positioning protrusion 49b fit in the positioning recess 77b and the positioning protrusion 77a fit in the water-stop member side positioning recess 49a. In this state, one end surface of the first divided member 40 is in contact with the first positioning portion 75a and the other end surface thereof is in contact with the second positioning portion 75b. In this way, the first divided member 40 is positioned in an axial direction thereof with respect to the first exterior member 72. In this state, the accommodation recess 48 of the first divided member 40 is open toward a side opposite to the water-stop member divided holding surface 75f. Thus, a mounting operation of the second divided member 50 into the accommodation recess 48 and the like can be performed with the first divided member 40 set in the first exterior member 72.

The second exterior member 82 includes a ceiling plate portion 83 and a pair of side wall portions 84. The ceiling plate portion 83 is in the form of a rectangular plate, similarly to the bottom plate portion 73. The pair of side wall portions 84 project from both sides of the ceiling plate portion 83. Uniting recesses 84q are formed in the outer surfaces of the side wall portions 84. Here, uniting extending pieces 84p are formed to extend from the outer surfaces of the side wall portions 84 toward tip sides thereof. A uniting recess, in which the uniting protrusion 74p can be arranged, is formed in a tip part of the uniting extending piece 84p. With the second exterior member 82 stacked on the first exterior member 72, the tip edges of the pair of side wall portions 74 and those of the pair of side wall portions 84 are arranged opposite to each other. Note that overlapping pieces of the tip parts of the pair of side wall portions 84 cover the outer sides of the tip edges of the pair of side wall portions 74. In this state, tip parts of the uniting extending pieces 84p ride over the uniting protrusions 74p and the uniting protrusions 74p enter the uniting recesses. In this way, the uniting protrusions 74p are hooked and retained in the uniting recesses 84q, and a united state of the first and second exterior members 72, 82 is maintained.

A water-stop member divided holding surface 85f in the form of a semi-circumferential surface is formed in a longitudinal intermediate part of the ceiling plate portion 83. A part of the outer periphery of the elastic water-stop member 30, particularly an outer peripheral part of the third divided member 60, is accommodated on the water-stop member divided holding surface 85f. The elastic water-stop member 30 is accommodated into a space formed by the water-stop member divided holding surfaces 75f and 85f.

A first positioning portion 85a is provided on one end part of the water-stop member divided holding surface 85f. The first positioning portion 85a is formed into an arc shape projecting further inward than the inner peripheral surface of the water-stop member divided holding surface 85f. The first positioning portion 85a positions the elastic water-stop member 30 by contacting one end surface of the third divided member 60. A semi-tubular holding portion 86a configured similarly to the semi-tubular holding portion 76a is formed on one end part of the ceiling plate portion 83. With the first and second exterior members 72, 82 united, the semi-tubular holding portions 76a, 86a sandwich and hold the coating member 24.

A second positioning portion 85b is provided on the other end part of the water-stop member divided holding surface 85f. The second positioning portion 75b is formed with a shallow recess. With the first and second exterior members 72, 82 united, the second positioning portion 85b positions the third divided member 60 by contacting the other end surface of the third divided member 60.

A positioning protrusion 87a and a positioning recess 87b are formed on and in the water-stop member divided holding surface 85f of the ceiling plate portion 83. The positioning protrusion 87a is configured similarly to the positioning protrusion 77a, and the positioning recess 87b is formed similarly to the positioning recess 77b. The positioning protrusion 87a and the positioning recess 87b are different from the positioning protrusion 77a and the positioning recess 77b in formation positions with respect to the elastic water-stop member 30. That is, the positioning protrusion 87a and the positioning recess 87b are formed near the coating member arrangement hole 32, out of the water-stop member divided holding surface 85f. Further, in a width direction of the water-stop member divided holding surface 85f, a positional relationship of the positioning protrusion 87a and the positioning recess 87b is laterally opposite to that of the positioning protrusion 77a and the positioning recess 77b. A water-stop member side positioning recess 69a, into which the positioning protrusion 87a is fittable, is formed at a position corresponding to the positioning protrusion 87a in the outer peripheral surface of the elastic water-stop member 30 on the side of the third divided member 60, and a water-stop member side positioning protrusion 69b fittable into the positioning recess 87b is formed adjacent to the water-stop member side positioning recess 69a.

Thus, if the posture of the third divided member 60 is opposite to the proper one, the positioning protrusion 87a interferes with the outer surface of the third divided member 60 and the water-stop member side positioning protrusion 69a interferes with the water-stop member divided holding surface 85f. The third divided member 60 and the second exterior member 82 can be set in a correct positional relationship based on whether the above interference is present or not.

The positioning protrusion 87a and the water-stop member side positioning recess 69a are examples of the erroneous assembly preventing protrusion and the erroneous assembly preventing recess, and the water-stop member side positioning protrusion 69a and the positioning recess 87b are also examples of the erroneous assembly preventing protrusion and the erroneous assembly preventing recess. Either one or both of these may be omitted.

Further, also when the first and third divided members 40, 60 are in incorrect positions, interference such as that of the positioning protrusion 77a with the outer surface of the third divided member 60 or that of the positioning protrusion 87a with the outer surface of the first divided member 40 possibly occurs. Thus, it is possibly suppressed that the first and third divided members 40, 60 are erroneously set in the first and second exterior members 72, 82.

With the third divided member 60 set in the second exterior member 82, the outer peripheral surface of the third divided member 60 is accommodated on the water-stop member divided holding surface 85f. In this state, the one end surface of the third divided member 60 is in contact with the first positioning portion 85a. Further, the other end surface of the third divided member 60 is in contact with the second positioning portion 85b. In this way, the third divided member 60 is positioned in an axial direction thereof with respect to the second exterior member 82. Since the accommodation recess 68 of the third divided member 60 is open toward a side opposite to the water-stop member divided holding surface 85f, an upper part of the second divided member 50 united with the first divided member 40 can be fit into the accommodation recess 68 in assembling the second exterior member 82 with the first exterior member 72.

An example of a manufacturing method of this wiring module 10 is described.

The wiring member 20 in which the linear wiring members 22 extend from the end part of the coating member 24 is prepared.

The positioning protrusion 77a of the first exterior member 72 is fit into the water-stop member side positioning recess 49a of the first divided member 40 and the water-stop member side positioning protrusion 49b of the first divided member 40 is fit into the positioning recess 77b of the first exterior member 72, whereby the first divided member 40 is set in the first exterior member 72.

Further, each linear wiring member 22 is pushed into the wiring member arrangement groove 52, 56 of the second divided member 50. The linear wiring member 22 passes through between the pair of guiding wall portions 54, 58 and is arranged into the wiring member arrangement groove 52, 56 by way of the elongated opening 52s, 56s. At this time, since the wiring member arrangement groove 52, 56 is shaped to have a depth larger than the radius of the linear wiring member 22 and the elongated opening 52, 56s is formed to have a width smaller than the diameter of the linear wiring member 22, the linear wiring member 22 is less likely to come out from the wiring member arrangement groove 52, 56.

In this state, the second divided member 50 is united with the first divided member 40 set in the first exterior member 72. In this way, the linear wiring members 22 are arranged in the linear wiring member arrangement holes 34 formed by the wiring member arrangement grooves 52 and the tip parts of the convex lid portions 42.

Further, the third divided member 60 is united with the second divided member 50. In this way, the linear wiring members 22 are held in the linear wiring member arrangement holes 34 formed by the wiring member arrangement grooves 56 and the tip parts of the convex lid portions 62.

The positioning protrusion 87a of the second exterior member 82 is fit into the water-stop member side positioning recess 69a of the third divided member 60 and the water-stop member side positioning protrusion 69b of the third divided member 60 is fit into the positioning recess 87b of the second exterior member 82, whereby the second exterior member 82 is put on the third divided member 60. Then, the uniting protrusions 74p are hooked and retained in the uniting recesses 84q. In this way, the first and second exterior members 72, 82 are kept in the united state. Then, the first, second and third divided members 40, 50 and 60 are compressed in a uniting direction between the water-stop member divided holding surfaces 75f and 85f, and the united state thereof is maintained.

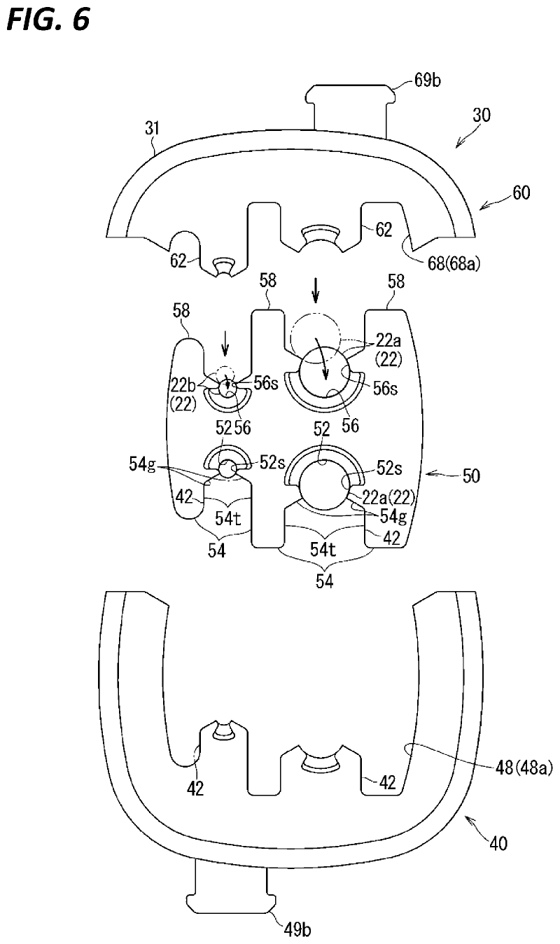

After the linear wiring members 22 are pushed into the wiring member arrangement grooves 52, 56, any one of the linear wiring members 22 may possibly remain to be arranged between the pair of guiding wall portions 54, 58 outside the elongated opening 52s, 56s without completely entering the wiring member arrangement groove 52, 56 like the linear wiring members 22 shown by two-dot chain lines in FIG. 6.

For example, in pushing the linear wiring member 22 into the wiring member arrangement groove 52, 56, a force for pushing the linear wiring member 22 is hard to act in a longitudinally intermediate part of the wiring member arrangement groove 52, 56 and the linear wiring member is thought to partially remain between the pair of guiding wall portions 54, 58. Even in this case, if an attempt is made to unite the first and third divided members 40, 60 with the second divided member 50, the convex lid portion 42, 62 enters between the pair of guiding wall portions 54, 58 and pushes the linear wiring member 22 between the pair of guiding wall portions 54, 58 into the wiring member arrangement groove 52, 56. Thus, the entire outer periphery of the linear wiring member 22 is easily surrounded by the inner peripheral surface of the wiring member arrangement groove 52, 56 and the tip side surface of the convex lid portion 42, 62.

Note that the above assembling order is an example and it is not necessarily essential that the assembly is performed in the above order.

According to the wiring module 10 and the elastic water-stop member 30 configured as just described, if the linear wiring member 22 cannot be pushed into the wiring member arrangement groove 52, 56 in arranging at least a part of the wiring member 20, here, the linear wiring member 22, into the wiring member arrangement groove 52, 56, the linear wiring member is arranged between the pair of guiding wall portions 54, 58. If the first and second divided members 40, 50 are united in this state, the convex lid portion 42 pushes the linear wiring member 22 between the pair of guiding wall portions 54 into the wiring member arrangement groove 52 and, thereafter, closes the elongated opening 52s. Thus, if the elastic water-stop member 30 has a divided structure, the linear wiring member 22 is more reliably accommodated into the linear wiring member arrangement hole 34 surrounded by the wiring member arrangement groove 52 and the convex lid portion 42 with the first and second divided members 40, 50 united. For example, a situation in which the linear wiring member 22 is sandwiched between the first and second divided members 40, 50 at a boundary other than in a part where the wiring member arrangement groove 52 is formed is suppressed. In this state, the wiring member arrangement groove 52 and the peripheral surface of the convex lid portion 42 are easily held in close contact with the periphery of the linear wiring member 22 is easily maintained, water intrusion along the linear wiring member 22 is more reliably suppressed and water stopping property can be improved.

The elastic water-stop member 30 is further provided with the third divided member 60, and the linear wiring members 22 are arranged also in the linear wiring member arrangement holes 34 surrounded by the wiring member arrangement grooves 56 of the second divided member 50 and the convex lid portions 42 of the third divided member 60. Thus, water can be stopped for the plurality of linear wiring members 22 between the first and second divided members 40, 50 and between the second and third divided members 50, 60.

Further, the second divided member 50 to be arranged between the first and second divided members 40, 60 is formed with the wiring member arrangement grooves 52 and 56. Thus, an operation of holding the linear wiring members 22 in the wiring member arrangement grooves 52 of the second divided member 50 facing the first divided member 40 and an operation of holding the linear wiring members 22 in the wiring member arrangement grooves 56 of the second divided member 50 facing the third divided member 60 can be performed simultaneously or successively one after the other. Further, an operation of uniting the second divided member 50 with the first divided member 40 and an operation of uniting the third divided member 60 with the united assembly of the first and second divided members 40, 50 can be performed thereafter. Thus, an operation of uniting the first, second and third divided members 40, 50 and 60 is easily performed.

Further, parts of the second divided members 50 facing the first and third divided members 40, 60 can be easily symmetrically shaped, and the first and third divided members 40, 60 are easily formed with parts having the same shape. Thus, the shape design of each component is facilitated.

Further, the wiring member arrangement groove 52, 56 has a depth larger than the radius of the linear wiring member 22, and the width of the elongated opening 52s, 56s is also smaller than the diameter of the linear wiring member 22. Thus, the linear wiring member 22 is less likely to come out from the wiring member arrangement groove 52, 56 and is easily held in a temporarily held state.

It is not essential that the wiring member arrangement grooves 52, 56 have the above shapes. For example, the wiring member arrangement groove may be shaped into a semicircular groove. In this case, the tip part of the convex lid portion may be shaped into a semicircular groove.

Further, since heights of the pairs of guiding wall portions 54, 58 are equal to or larger than the radii of the linear wiring members 22, the linear wiring members 22 are less likely to be detached from the pairs of guiding wall portions 54, 58. If the heights of the pairs of guiding wall portions 54, 58 are equal to or larger than the diameters of the linear wiring members 22, the linear wiring members 22 are even less likely to be detached from the pairs of guiding wall portions 54, 58.

Further, since base end parts of the pair of guiding wall portions 54, 58 are formed to have the guide surfaces 54g, the spacing between which is gradually narrowed toward the elongated opening 52s, 56s, the linear wiring member 22 is easily guided into the elongated opening 52s, 56s by the guide surfaces 54g and smoothly pushed into the wiring member arrangement groove 52, 56.

Further, the first, second and third divided members 40, 50 and 60 can be maintained in the united state by the united structure of the first and second exterior members 72, 82.

Note that, besides the above one, the exterior member may be an adhesive tape, a band or the like wound around the elastic water-stop member 30 or may be a resin tube or a metal tube externally fit to the elastic water-stop member 30.

Further, since the exterior member 70 and the elastic water-stop member 30 are formed with the positioning protrusions 77a, 87a, the positioning recesses 77b, 87b, the water-stop member side positioning recesses 49a, 69a and the water-stop member side positioning protrusions 49b, 69b and the like as the erroneous assembly preventing protrusions and the erroneous assembly preventing recesses, the assembly of the elastic water-stop member 30 in a wrong posture with the exterior member 70 is suppressed.

### [Modifications]

Various modifications are described based on the above embodiment.

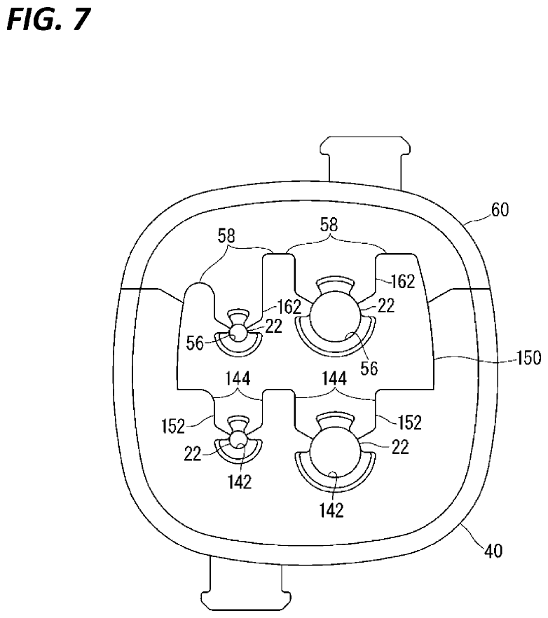

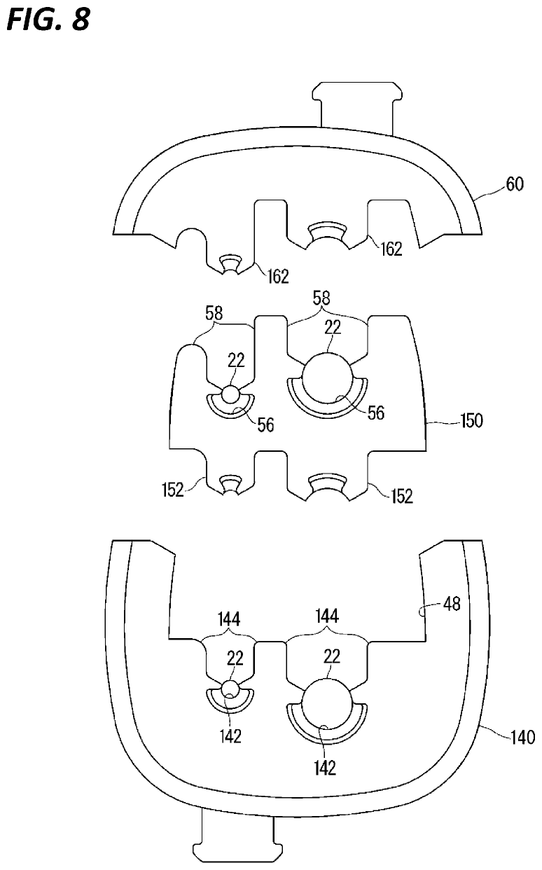

As shown in FIGS. 7 and 8, in a relationship between a first divided member 140 corresponding to the first divided member 40 and a second divided member 150 corresponding to the second divided member 50, the first divided member 140 may be formed with wiring member arrangement grooves 142 and pairs of guiding wall portions 144. Here, two wiring member arrangement grooves 142 are formed in a bottom part of an accommodation recess 48 (central divided member accommodating portion) in the first divided member 140, and each of the two wiring member arrangement grooves 142 is formed with one pair of the guiding wall portions 144. The wiring member arrangement grooves 142 and the pairs of guiding wall portions 144 may be configured similarly to the wiring member arrangement grooves 52 and the pairs of guiding wall portions 54.

Further, convex lid portions 152 are formed in parts facing the first divided member 140, out of the second divided member 150. Here, one convex lid portion 152 is formed to correspond to the two wiring member arrangement grooves 142. The convex lid portions 152 may be configured similarly to the convex lid portions 42.

In a relationship between the second divided member 150 and a third divided member 60, the second divided member 150 is formed with wiring member arrangement grooves 56 and pairs of guiding wall portions 58 and the third divided member 60 is formed with convex lid portions 62 as in the above embodiment.

According to this modification, the first and second divided members 140, 150 can be united with the linear wiring members 22 arranged in the wiring member arrangement grooves 142 of the first divided member 140. Then, the third divided member 60 can be united with the first and second divided members 140, 150 with the linear wiring members 22 arranged in the wiring member arrangement grooves 56 of the second divided members 150.

Thus, in the configuration of assembling the second divided member 150 on the first divided member 140 and further assembling the third divided member 60 on the second divided member 150, the linear wiring members 22 are arranged with respect to the first divided member 140 and the linear wiring members 22 are arranged with respect to the second divided member 150 in accordance with that assembling order. Thus, an operation of successively assembling the respective components from above is easily performed in accordance with the assembling order of those.

Although the elastic water-stop member 30 is divided into three parts in the above embodiment, it is sufficient to divide an elastic water-stop member into a plurality of parts. For example, the elastic water-stop member may have a two-divided structure or may be divided into four or more parts.

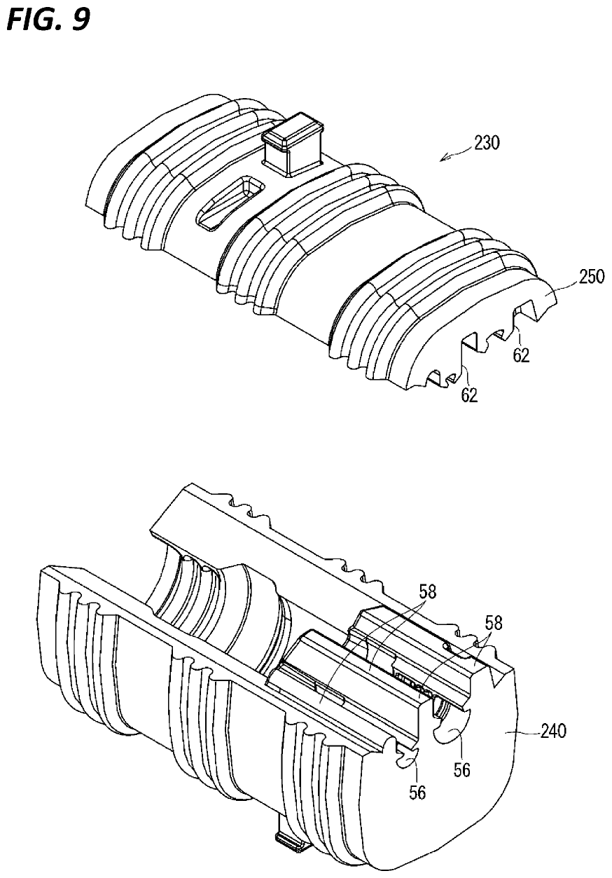

FIG. 9 shows an example in which an elastic water-stop member 230 corresponding to the elastic water-stop member 30 has a two-divided structure. The elastic water-stop member 230 is provided with two divided members 240, 250. One divided member 240 is configured as if the first and second divided members 40, 50 in the above embodiment were integrally formed by a mold or the like. The other divided member 250 is configured similarly to the third divided member 60.

Also in this example, the divided member 240 is formed with wiring member arrangement grooves 56 and pairs of guiding wall portions 58 and the divided member 250 is formed with convex lid portions 62 as in the above embodiment. Thus, even if the linear wiring member 22 is present between the pair of guiding wall portions 58 at the time of uniting the divided members 240, 250, the linear wiring member 22 is pushed into the wiring member arrangement groove 56 by the convex lid portion 62. Thus, the linear wiring member 22 is more reliably arranged in a linear wiring member arrangement hole 34 surrounded by the wiring member arrangement groove 56 and the convex lid portion 62.

Note that the respective components described in the above embodiment and each modification can be appropriately combined without contradicting each other.

### LIST OF REFERENCE NUMERALS

10 wiring module
20 wiring member
22 (22a, 22b) linear wiring member
24 coating member
24a end part
30, 230 elastic water-stop member
31 annular protrusion
32 coating member arrangement hole
34 linear wiring member arrangement hole
36 intermediate divided member accommodation hole
40, 140 first divided member
41a, 61a divided member erroneous assembly preventing protrusion
42, 62 convex lid portion
48, 68 accommodation recess
48a, 68a intermediate divided member accommodating portion
49 coating accommodation recess
49a, 69a water-stop member side positioning recess
49b, 69b water-stop member side positioning protrusion
50, 150 second divided member
51a divided member erroneous assembly preventing recess
52, 56, 142 wiring member arrangement groove
52s, 56s elongated opening
54, 58, 144 guiding wall portion
54g guide surface
54t restricting surface
60 third divided member
70 exterior member
72 first exterior member
73 bottom plate portion
74, 84 side wall portion
74p uniting protrusion
74q guide protrusion
75a, 85a first positioning portion
75b, 85b second positioning portion
75c restricting wall portion
75f, 85f water-stop member divided holding surface
76a, 86a semi-tubular holding portion
77a, 87a positioning protrusion
77b, 87b positioning recess
82 second exterior member
83 ceiling plate portion
84p uniting extending piece
84q uniting recess
240, 250 divided member

1. A wiring module, comprising:
a wiring member including at least one linear wiring member; and
an elastic water-stop member mounted on a part in a longitudinal direction of the wiring member,
the elastic water-stop member including a first divided member and a second divided member,
one of the first and second divided members being formed with a wiring member arrangement groove having openings on both end sides and an elongated opening,
a pair of guiding wall portions being formed to project outwardly of the wiring member arrangement groove from both side edges of the elongated opening of the wiring member arrangement groove,
the other of the first and second divided members being formed with a convex lid portion for closing the elongated opening by being arranged between the pair of guiding wall portions, and
at least a part of the wiring member being arranged in a wiring member arrangement hole surrounded by the wiring member arrangement groove and the convex lid portion with the first and second divided members united.

2. The wiring module of claim 1, wherein:
the wiring member includes a plurality of the linear wiring members,
the elastic water-stop member further includes a third divided member,
one of the second and third divided members is formed with the wiring member arrangement groove and the pair of guiding wall portions,
the other of the second and third divided members is formed with the convex lid portion, and
the plurality of linear wiring members are arranged in the wiring member arrangement holes each surrounded by the wiring member arrangement groove and the convex lid portion between the first and second divided members and between the first and third divided members with the first, second and third divided members united.

3. The wiring module of claim 2, wherein:
each of a part facing the first divided member and a part facing the third divided member, out of the second divided member, is formed with the wiring member arrangement groove and the pair of guiding wall portions, and
each of the first and third divided members is formed with the convex lid portion.

4. The wiring module of claim 2, wherein:
the first divided member is formed with the wiring member arrangement groove and the pair of guiding wall portions,
a part facing the first divided member, out of the second divided member, is formed with the convex lid portion,
a part facing the third divided member, out of the second divided member, is formed with the wiring member arrangement groove and the pair of guiding wall portions, and
the third divided member is formed with the convex lid portion.

5. The wiring module of claim 1, wherein a depth of the wiring member arrangement groove is larger than a radius of the linear wiring member and a width of the elongated opening is smaller than a diameter of the linear wiring member.

6. The wiring module of claim 1, wherein heights of the pair of guiding wall portions are equal to or larger than a radius of the linear wiring member.

7. The wiring module of claim 1, wherein the pair of guiding wall portions have guide surfaces, a spacing between the guide surfaces being gradually narrowed toward the elongated opening.

8. The wiring module of claim 1, further comprising an exterior member including a first exterior member and a second exterior member unitable with each other,
wherein the elastic water-stop member is accommodated in the exterior member with the first and second exterior members united.

9. The wiring module of claim 8, wherein:
one of the exterior member and the elastic water-stop member is formed with an erroneous assembly preventing protrusion, and
the other of the exterior member and the elastic water-stop member is formed with an erroneous assembly preventing recess, the erroneous assembly preventing protrusion being fit into the erroneous assembly preventing recess.

10. An elastic water-stop member to be mounted on a part in a longitudinal direction of a wiring member including at least one linear wiring member, comprising:
a first divided member; and
a second divided member,
one of the first and second divided members being formed with a wiring member arrangement groove having openings on both end sides and an elongated opening,
a pair of guiding wall portions being formed to project outwardly of the wiring member arrangement groove from both side edges of the elongated opening of the wiring member arrangement groove,
the other of the first and second divided members being formed with a convex lid portion for closing the elongated opening by being arranged between the pair of guiding wall portions, and
a wiring member arrangement hole capable of arranging at least a part of the wiring member therein by being surrounded by the wiring member arrangement groove and the convex lid portion being formed with the first and second divided members united.
